(19) United States
(12) Patent Application Publication
(10) Pub. No.: US 2016/0122496 A1
(43) Pub. Date: May 5, 2016

(54) METHOD AND INDUSTRIAL PROCESS FOR RECOVERING RAW MATERIALS FROM PAPER-CONTAINING WASTES BY MEANS OF IONIC LIQUIDS

(71) Applicant: TULIPORT S.À.R.L., Luxemburg (LU)

(72) Inventor: Rainer Pommersheim, Mainz (DE)

(21) Appl. No.: 14/894,606

(22) PCT Filed: May 19, 2014
(86) PCT No.: PCT/EP2014/060206

§ 371 Date: Nov. 30, 2015

(30) Foreign Application Priority Data
May 31, 2013 (DE) 10 2013 009 138.1

(51) Int. Cl. C08J 11/08; C22B 7/00; C22B 21/00

(52) U.S. Cl. CPC C08J 11/08; C22B 21/0023; C22B 7/008

(57) ABSTRACT

2.1 At present, actual recovery of the materials in their original form from wastes such as, for example, used paper, material mixtures, composite packaging, etc. is possible only to a limited degree, if at all. The cellulose in particular is currently hardly recovered at all from paper wastes as primary material. The present invention provides a homogeneous method in which all three main components, for example of composite packaging or mixtures of composite packaging materials, specifically cellulose, plastic and metal, can be recovered in their primary form and in a quality corresponding very substantially to new material. 2.2 According to the invention, this is accomplished in a solvent-based process. This involves using a suitable ionic liquid for leaching the cellulose out of the paper component of the waste, and this step is combined with other solvent-based steps so as to give rise to a homogeneous process in which both cellulose and plastic and metal can be recovered. In the method, the plastic is likewise leached out of the waste, but with conventional solvents such as hydrocarbons. The metal is removed in solid form. According to the composition of the raw material, the process may afford only one of the abovementioned materials, two or all three. 2.3 Such a method can be used for industrial scale recovery of the abovementioned materials.

The invention relates to a method and an industrial process for recovery of raw materials from wastes such as, for example, packaging materials or composite materials as well as other materials or material mixtures. A component of these materials or mixtures in this case is preferably paper or another cellulose-based substance. Further components are usually plastic and/or aluminium or other metals. These substances are recovered in their primary form as raw material in the method according to the invention. In this case, the cellulose is dissolved in so-called ionic liquids and the plastic is dissolved in suitable hydrocarbons and then precipitated again. The metal fraction is separated as solid from the solutions. The solvents are recovered. Since a purification thus takes place on a molecular level, the raw materials obtained are of high purity and quality. They can then be used as conventionally obtained raw materials and further processed.

It is no longer possible to imagine current product cycles without packaging materials. In particular, in the packaging of foodstuffs but also other consumer materials, very high-quality substances such as paper, i.e. cellulose, plastics and metals such as, for example, aluminium are used here. Although in the past few years increased efforts have been made in relation to the recovery of these materials, nevertheless at the present time the majority of these substances are utilized thermally i.e. burnt. Take-back systems such as for example, in Germany the dual system or the Green Point, have not been able to change much about this. Consequently, enormous amounts of valuable raw materials are lost annually.

If we examine the rubbish which accumulates from packaging materials somewhat more closely, we can divide this into two groups. On the one hand, this comprises mixtures of packagings which for their part consist of individual materials, on the other hand so-called composite packagings which are constructed of individual layers of different substances. Naturally, in practice mixtures of these two classes are frequently the rule. Regardless of whether mixtures of packagings or composite packagings are considered, the resulting packaging waste usually always consists of a paper fraction, i.e. cellulose, a plastic fraction and a metal fraction such as, for example, aluminium.

Although the predominant fraction of packaging waste is burnt, there are also processes used industrially which have as their aim an at least partial recovery of the raw materials from these packagings. If the packagings comprise mixtures, at the present time it is possible to separate them into the individual components on an industrial scale. However, the situation is more difficult with composite packagings. Here, in almost all the processes used industrially at the present time, only a separation of the paper fraction from the aluminium/plastic composition takes place. An actual recovery of the materials in their original form is only possible to a limited extent or not at all.

The consequence is that the recovered materials can only be used to produce secondary products such as, for example, cardboard packagings from the paper fraction and injection moulded items of inferior quality from the plastic/aluminium composite.

If, on the other hand the substances from these packaging materials are used as primary raw materials, they have a crucial advantages compared with the conventionally obtained materials: they need not pass through a whole series of process steps which are required to produce conventional raw materials. If we consider in this context the efforts involved for example in obtaining metallic aluminium from bauxite or in synthesizing polyethylene from petroleum or purely and simply in obtaining cellulose from the plant in the field, it becomes clear how advantageous it is to use these materials from packaging waste.

This advantage is particular clear in the case of cellulose.

The oldest and at the same time the most widely used process for processing cellulose is the viscose (xanthogenate) process. Here the cellulose is converted into a soluble derivative. This derivatised cellulose can then be further processed. This process uses extremely caustic and environmentally polluting chemicals such as, for example, sodium hydroxide solution, carbon disulphide etc.

For some years however, new very promising environmentally friendly solvents have become available which are suitable for such a process. By means of these so-called ionic liquids, i.e. liquid ionogenic compounds, cellulose can be dissolved under certain reaction conditions. The cellulose can be precipitated out from this solution again by a precipitating agent, usually water.

Thus, for example, in the journal “Chemical Fibers International”, No. 6/2006 on page 344 a method is described in which cellulose is dissolved with the aid of [EMIM]acetate, i.e. an ionic liquid, and then cellulose fibres are obtained therefrom. The use of ionic liquids enables a direct transfer of cellulose into solution, in which case a previous derivatization is not necessary.

However, such a method is subject to certain restrictions when its use for pulps in general is concerned. Thus, for example, humines prevent the reusability of the solvent, i.e. the ionic liquid in the case of dissolving wood, bamboo, coconut shells or similar starting materials.

In packaging materials (paper, cardboard packagings etc.) and composite packagings, however the interfering humines have already been removed by the previous classical production process and the cellulose has a sufficient quality. Accordingly a method such as described in the present invention which operates with ionic liquids as solvent and uses the paper from waste as raw material source is well suited for recovering cellulose for this class of pulps. This enables a particularly economical and environmentally compatible recovery of cellulose, a particularly valuable primary material.

Methods which, in contrast to this, are based on the use of conventional solvents such as, for example, hydrocarbons have been known for years in particular for recycling plastic wastes and can be found at several places in the literature.

Thus, for example, the patent application EP06754237 describes a method for recycling plastics which contain at least two polystyrene-based polymers, copolymers or blends thereof. In this case, the different polymers are initially brought into solution and then separated from one another by a fractionated precipitation.

In the application EP06743132 the use of solvents is used inter alia for the separation of polymers based on polystyrene, copolymers thereof and/or blends from polymers having flame retardant additives.

EP1392766 has as its subject matter a method for the recovery of polyolefins such as, for example, LDPE from used plastic films comprising the following steps: extracting low-molecular components from the material which is dissolved in a second organic solvent, selective dissolution of the film material thus treated, precipitation of at least one interfering polymer from the solution and recovering the polyethylene from the remaining polymer solution.

Other property rights are primarily concerned with the problem of separating individual fractions from a waste mixture by means of physical methods. The application EP2364246 relates to a method and a system for separating individual valuable materials, in particular milled plastic waste containing film, composite film and hard plastic parts. Any interfering substances are separated from the plastic waste and the plastic waste is divided into different fractions by a float separation.

EP 2463071 is concerned with a method for processing composite packagings such as, for example, tetra-packs which are known to originally contain 75% cellulose, 20% LDPE and about 5% aluminium. In a first step the cellulose fraction is removed. The invention concentrates on the further processing of the remaining composite which after the first treatment consists of 4% cellulose, 78% LDPE and 18% aluminium. The aim is to produce a granular material which does not contain the plastic as a single type but makes this injection-mouldable. This is achieved by grinding the particles very small so that the metal fractions do not disturb the injection moulding process. Such a granular material can be used to produce low-quality secondary products as mentioned in the introductory part.

The invention EP 1979497 finds a different way. Here the plastic aluminium composite is separated. This is accomplished by a multi-stage melting. In a first step the plastic is melted and separated. Then a melt is produced from the aluminium where the adhering plastic residues are burnt.

The literature listed here as representative each for themselves present solution approaches as to how composite materials or material mixtures can be separated or individual components therefrom can be supplied to recycling. However, none of these is a complete solution or however the materials obtained to not correspond to new raw materials in terms of their condition and quality.

Starting from these facts of the matter, it is the object of the present invention to describe a homogenous method in which all three main components, e.g. of composite packagings or mixtures of packaging materials, and specifically cellulose, plastic and metal can be recovered in their primary form and in a quality which largely corresponds to new materials.

According to the invention, this is achieved in a solvent-based process. The core idea is to use suitable ionic liquids to leach the cellulose out from the paper fraction of the waste and to link this step with other solvent-based steps so that a homogeneous method is obtained therefrom in which cellulose and also plastic and metal can be recovered. In this case, the plastic is also leached from the waste but with conventional solvents such as hydrocarbons. The metal is separated as solid. According to the composition of the input material, the process can deliver only one of the aforesaid materials, two or all three.

A central element of the invention is accordingly to use the paper-containing fraction from the waste as source of raw material to recover new-quality cellulose in high quality. The paper waste is known to comprise already processed cellulose which, for example, lacks the humines. Therefore ionic liquids can be used economically, which is not the case with other starting materials such as, for example, wood.

The process is accordingly configured as follows:

Paper-containing waste such as is collected and supplied from recycling depots is used as raw material, the so-called input. Accordingly, it can contain both composite packagings and also mixtures of different packagings or also waste paper. In addition to the actual valuable materials, this material also contains mechanical impurities such as, for example, paper, glass, metals, adhering products and food residue etc. During the mechanical preparation, these impurities are removed as part of the pre-treatment. Also during the pre-treatment the materials are comminuted and separated in a density separating step so that they can be supplied to further processing.

The faction thus obtained is then subjected to a selective treatment with solvents. The substances are completely dissolved apart from the aluminium. The insoluble aluminium can be recovered in pure form from the process by filtration or gravimetric separating methods (sedimentation, centrifugation) straight after the process of dissolving the cellulose and the polyethylene.

As a result of the fact that quite specific solvents are used, it is possible to specifically bring the cellulose, and in a further step also the polyethylene or other plastics into solution and then precipitate. Additives, impurities and even damaged polymer chains are retained. As a result, almost each individual molecule is purified. The cellulose obtained by drying and also the granulated polyethylene or other plastic does not differ molecularly and also in properties from conventionally obtained new material.

The used solvents are reconditioned and returned to the process. As a result of this closed cycle, environmental pollution is avoided and the economic viability of the method is increased.

The choice of suitable solvents is accordingly of decisive importance in the process. In this connection, a distinction should be made between two classes of substances which are to be brought into solution in the process: the plastics and the cellulose.

With regard to the plastics which occur in the mixtures, a distinction must be made between the polyolefins such as PE and PP, polystyrene-based plastics, polyesters and other plastics. When the plastics are present in free form, i.e. not as parts of composite packagings, they can be separated from one another as a result of their different density in separation steps preceding the actual process and treated separately in the main process.

In the case of composite packagings, the plastic must therefore be separated, i.e. leached from the composite in the actual process. This mainly comprises polyethylene, i.e. a polyolefin. This class of plastic is characterized by a high resistance with respect to conventional solvents such as, for example, acetone, ethyl acetate etc.

However, at temperatures above 60° C. polyethylene can be dissolved in some hydrocarbons such as, for example xylenes, hexanes etc. Also pre-treatments with chemicals have a positive effect on the solubility since the hydrophobicity of the surface can thereby be reduced.

In the method described here, individual ones of the aforesaid solvents can be used or mixtures of different liquid hydrocarbons which are specially matched to the polyethylene present in the packagings.

According to the invention, so-called ionic liquids are used for dissolving the cellulose from the packaging waste in general but also especially from composite packagings.

The term ionic liquids is understood as liquids which are exclusively constructed of ions. This comprises molten salts of organic compounds or eutectic mixtures of organic salts and inorganic salts.

The fundamental suitability of ionic liquids as solvents for polysaccharides, i.e. also for cellulose, has been known in the literature for years. Such an ionic liquid is, for example, 1-butyl-3-methylimidazolium chloride, [BMIM]Cl. [BMIM]Cl effectively dissolves cellulose since the chloride anion acts as acceptor of hydrogen bridges. The interaction of the chloride with the hydroxyl groups of the cellulose results in a dissolution of the supramolecular order of the cellulose and the individual biomolecules are enclosed by the ionic liquid.

Another suitable solvent for the method described here is, for example, ethyl methylimidazolium acetate [EMIM]OAc (see on this matter also the introductory part). Very good results can be achieved by dissolving the cellulose for example with [BMIM]CF₃SO₃ as solvent.

As a result, with the aid of these ionic liquids, solutions can be produced from the paper and pulp fractions from waste and composite packagings which contain high fractions of cellulose (up to 50% and more).

The regeneration of the dissolved cellulose is then accomplished by adding water. In this case, a defined hydrogen bridge network is formed where the cellulose can be precipitated in crystalline form from the solution and can be separated as solid.

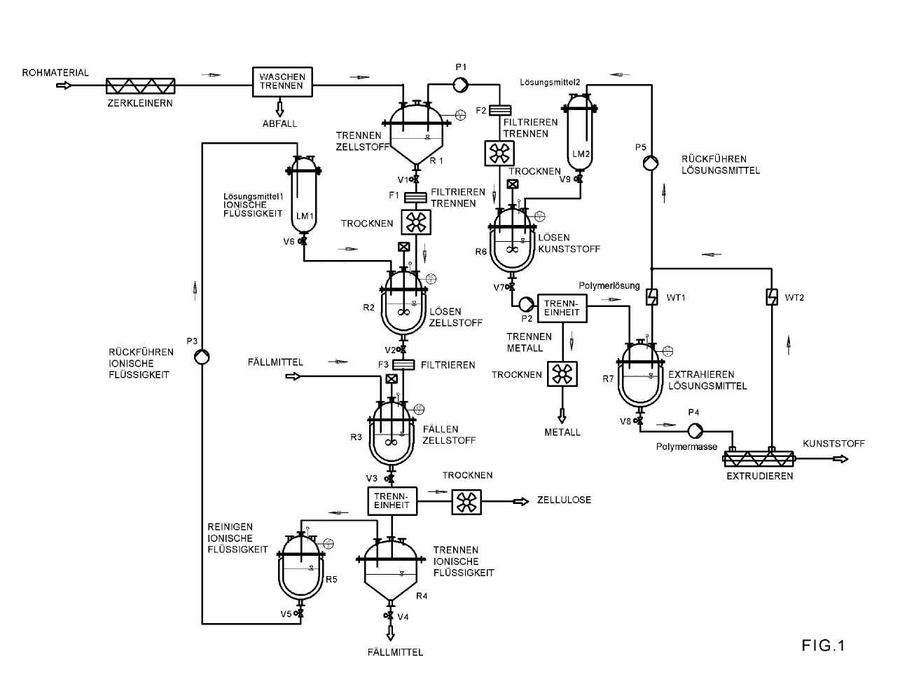

Some examples for the industrial implementation of such a method are presented hereinafter. This involves the process depicted in [FIG. 1]:

### EXAMPLE 1

### Raw Material With High Paper Fraction

In a first step the waste containing valuable materials or the packaging rubbish is sorted and purified. A fraction which principally consists of paper-containing wastes or waste paper is used as input.

This raw material is comminuted [COMMINUTING] and in one or more adjoining washing and separating steps [WASHING/SEPARATING] is separated from adhering impurities, other materials and plastics. The separation takes place in density separating basins with suitable density separating media such as are usually used in recycling plants.

In the material thus prepared, the paper fraction is purified once again by means of water in the reactor [R1] so that a relatively clean, aqueous pulp fraction is produced.

From the pulp fraction the solid fraction is then filtered out [F1] and dried [DRYING] and conveyed into the reactor [R2]. Here it is mixed with the ionic liquid from the supply tank [LM1] where the cellulose goes into solution. The liquid thus obtained is then separated from mechanical impurities and undissolved fractions by the filter [F3] and supplied to precipitation in [R3].

In [R3] the cellulose is precipitated by supplying water [PRECIPITATING AGENT], with the result that a solid, cellulose, is produced. This is then separated in a separating unit [SEPARATING UNIT] and possibly washed again. The separating unit can be a filter, a centrifuge, a decanter or another device which is suitable for separating a solid from a suspension. The cellulose thus obtained is then dried and can be further processed as conventionally obtained cellulose.

In [R4] the ionic liquid is then recovered from the liquid from the separating unit. Since ionic liquids are not usually miscible with water, the separation can take place gravimetrically as in other two-phase systems. Possibly a centrifuge can also be used. The ionic liquid is then purified in [R5], for example, by distillation and returned into the cycle via [P3].

### EXAMPLE 2

### Raw Material Having a High Fraction of Composite Packagings

As in Example 1, here also in a first step the waste containing valuable materials or the packaging rubbish is sorted and purified. A fraction which principally consists of composite packagings is used as input.

This input material is comminuted [COMMINUTING] and in one or more adjoining washing and separating steps [WASHING/SEPARATING] is separated from adhering impurities, other materials and plastics. The separation takes place in density separating basins with suitable density separating media such as are usually used in recycling plants.

In the material thus prepared, the paper fraction is released from the remaining composite by means of water in the reactor [R1] so that two fractions are obtained: the pulp and the remaining composite.

The pulp fraction from [R1] is further processed as described in Example 1.

The plastic/aluminium composite from [R1] is conveyed as suspension via [P1] into the filtering and separating unit F2. P1 can also be a screw conveyor. In [F2] the solid fraction is separated. It is then dried [drying] and conveyed into [R6]. Here the plastic, i.e. here the polyethylene (PE) is dissolved from the composite by adding a suitable hydrocarbon or mixture as solvent [solvent 2] from the supply tank [LM2].

The new suspension is then passed into a separating unit [SEPARATING UNIT] which can be designed either as a filter, a decanter or as a centrifuge. Here, the metal, i.e. the aluminium is separated from the PE solution as solid and then dried [DRYING]. Then it can be supplied to further processing as conventionally obtained aluminium. From the PE solution from the separating unit, in [R7] the solvent is separated by distillation, cooled via [WT1] and returned via [P5] into the supply tank [LM2]. The resulting polymer mass which still contains a high solvent fraction is conveyed into an extruder where the remaining solvent evaporates. The solvent is condensed in [WT2] and conveyed back into the cycle. The plastic obtained (PE) can be further processed as conventionally produced PE.

### EXAMPLE 3

### Raw Material as Mixture of Different Materials

As in the preceding examples, here also in a first step the waste containing valuable materials or the packaging rubbish is sorted and purified. A fraction which consists of a mixture of different materials is used as input.

This input material is comminuted [COMMINUTING] and in one or more adjoining washing and separating steps [WASHING/SEPARATING] is separated from adhering impurities. The separation takes place in density separating basins with suitable density separating media such as are usually used in recycling plants.

In the material thus prepared, the paper fraction is separated from the remaining mixture in the reactor [R1]. This can be accomplished as part of a density separation as is used conventionally in recycling plants.

The paper-containing mass is separated via the filter [Fl] and further processed as described in Example 1.

The remaining solid from [R1] which inter alia contains metal and different plastics is separated in the unit [F2] and conveyed into [R6]. Here the different plastics are now sequentially dissolved by using different solvents and further processed as described in Example 2.

It is also feasible that the different plastics and the metal are already separated from one another in an upstream density separating stage and that in [R3] the plastics are purified merely by the dissolution.

The metal is separated as described in Example 2. Usually this is only aluminium If this is a mixture of different metals, these must then be separated conventionally.

FIG. 1

[left to right, top to bottom]
RAW MATERIAL
COMMINUTING
WASHING/SEPARATING
Solvent 2
WASTE
SEPARATING PULP
FILTERING SEPARATING
Solvent 1 IONIC LIQUID
DRYING
FILTERING SEPARATING
DRYING
DISSOLVING PLASTIC
RETURNING SOLVENT
DISSOLVING PULP
SEPARATING UNIT
Polymer solution
RETURNING IONIC LIQUID
PRECIPITATING AGENT
FILTERING
SEPARATING METAL
DRYING
EXTRACTING SOLVENT
PRECIPITATING PULP
METAL
Polymer mass
EXTRUDING
PLASTIC
SEPARATING UNIT
DRYING
CELLULOSE
PURIFYING IONIC LIQUID
SEPARATING IONIC LIQUID
PRECIPITATING AGENT

1. Method and industrial process for the recovery of various raw materials from paper-containing wastes in a homogeneous procedure, characterized in that the cellulose is initially dissolved using ionic liquids and then recovered by precipitation.

2. The method and industrial process according to claim 1, characterized in that some of the plastics from the raw material are also obtained by a solvent-based process.

3. The method and industrial process according to claim 1, characterized in that the ionic liquid used, which is used to dissolve the cellulose is a compound of the A⁺B⁻ type which contains as cation an imidazolium ion such as, for example, methyl imidazole, butyl imidazole etc. and as anion a halide such as for example Cl⁻ or Br⁻, an acetic acid radical such as for example an acetate or a triflate anion of the type CF₃SO₃⁻ or similar or which is a mixture of several ionic liquids.

4. The method and industrial process according to claim 1, characterized in that liquid hydrocarbons or mixtures of the same are used as solvents to recover plastics.

5. The method and industrial process according to claim 1, characterized in that after the removal of the cellulose and the plastic, the metal is obtained directly as solid.

6. The method and industrial process according to claim 1, characterized in that both waste paper, paper waste, mixtures of different wastes and also composite packagings or mixtures of the same can thus be processed with other materials.

7. The method and industrial process according to claim 1, characterized in that the waste paper, paper waste or the paper-containing fraction from waste mixtures serve as a raw material source for recovery of cellulose by means of ionic liquids.

8. The method and industrial process according to claim 1, characterized in that therein some or all of the following process steps occur:
comminuting the raw material
purifying the raw material
separating the cellulose-containing fraction
drying the cellulose-containing fraction
dissolving the cellulose in an ionic liquid
- precipitating the cellulose with a precipitating agent such as, for example, water
separating the cellulose as solid and drying the cellulose
separating the ionic liquid from the precipitating agent for the cellulose
purifying and returning the ionic liquid
dissolving the plastic
separating the metal as solid and drying the metal
extracting the solvent from the polymer solution
recovering the remaining solvent from the plastic extruding the plastic.

9. The system according to claim 1 which operates according to a method according to claim 1, characterized in that it comprises one or more of the following main components according to FIG. 1:
storage container for the ionic liquid [LM1]
separating unit for the cellulose fraction [R1]
drier for the cellulose fraction, for the metal and for the cellulose
storage container [LM2] for the solvent for the plastic
container for dissolving [R2] and for precipitating the cellulose [R3]
separating unit for separating the cellulose or separating unit for the metal
device for separating the ionic liquid from precipitating agent [R4]
device for purifying the cellulose
container for dissolving the plastic [R6]
device for extraction of solvent from the polymer solution [R7]
extruder for the plastic
heat exchanger [WT1, 2 . . . ], filter [F1, 2 . . . ], pumps [P1, 2 . . . ] etc.

10. The system according to claim 9, characterized in that it operates according to FIG. 1 and/or its components are arranged and/or interconnected according to FIG. 1 or in similar manner.
